(19) United States
(12) Patent Application Publication
(10) Pub. No.: US 2021/0255518 A1
(43) Pub. Date: Aug. 19, 2021

(54) MULTI-LAYER OPTICAL MATERIALS SYSTEMS AND METHODS OF MAKING THE SAME

(71) Applicant: Purdue Research Foundation, West Lafayette, IN (US)

(72) Inventors: YIFEI SUN, West Lafayette, IN (US); Shriram Ramanathan, West Lafayette, IN (US)

(73) Assignee: Purdue Research Foundation, West Lafayette, IN (US)

(21) Appl. No.: 17/266,100

(22) PCT Filed: Aug. 7, 2019
(86) PCT No.: PCT/US19/45446

§ 371 Date: Feb. 4, 2021

Related U.S. Application Data
(60) Provisional application No. 62/716,662, filed on Aug. 9, 2018.

(51) Int. Cl. G02F 1/1524; B32B 17/10; G02F 1/1333; G02F 1/155; G02F 1/1343; G02F 1/1523

(52) U.S. Cl. CPC G02F 1/1524; B32B 17/10036; B32B 17/10174; G02F 1/1525; G02F 1/133302; G02F 1/155; G02F 1/13439; B32B 17/10513

(57) ABSTRACT

An electrochromic system is disclosed which includes a first glass layer having a bottom side and a top side, the top side coated with a first transparent conductor layer, an electrolyte layer formed adjacent to the first transparent conductor layer, an electrochromic layer formed adjacent to the electrolyte layer, and a second glass layer having a top side and a bottom side, the bottom side coated with a second transparent conductor layer and coupled to the electrochromic layer.

### CROSS-REFERENCE TO RELATED APPLICATIONS

The present patent application is related to and claims the priority benefit of U.S. Provisional Patent Application Ser. No. 62/716,662 filed 9 Aug. 2018, the contents of which are hereby incorporated by reference in its entirety into the present disclosure.

### STATEMENT REGARDING GOVERNMENT FUNDING

This invention was made with government support under DMR-1609898 awarded by National Science Foundation, and under N00014-16-1-2398 awarded by the Office of Naval Research. The government has certain rights in the invention.

### TECHNICAL FIELD

The present disclosure generally relates to tunable optical elements, especially for use in light transmission apparatuses such as smart windows, smart mirrors, and smart eye goggles.

### BACKGROUND

This section introduces aspects that may help facilitate a better understanding of the disclosure. Accordingly, these statements are to be read in this light and are not to be understood as admissions about what is or is not prior art.

In the context of the present disclosure, a smart window is an optical system whose optical transmission properties are altered when electric voltage or other stimulus such as temperature is applied. Generally, the smart window is a multilayer system that has a transparent glass as one of its layers. The color or the degree of transparency of the window can be modulated between opaque or translucent and transparent. As a key element of smart windows, electrochromic material is a component where color change happens and could find a broad range of applications to reduce the energy consumption and lighting costs of commercial vehicles and buildings that utilize smart windows. Ideal electrochromic materials demonstrate large and reversible optical transmittance change in response to an external electrical stimulus. The common electrochromic materials can be classified into three types: metal oxides, conducting polymers and inorganic non-oxides. The typical examples of metal oxides electrochromic materials include tungsten oxides (WO₃), niobium oxide (Nb₂O₅), and titanium oxide (TiO₂). Polyaniline and polypyrrole films have been extensively investigated as electrochromic polymer. Also, as typical organic electrochromic material, the Prussian blue (PB) (Iron(II,III) hexacyanoferrate(II,III) CAS Number 14038-43-8) and its related analogs are studied. However, these electrochromic materials face challenges due to the drawbacks of low coloration efficiency, possible structural transformations when large dopant concentration is inserted into the lattice and slow switching time (tens of seconds or more for coloring and bleaching, respectively).

Thus, there exists an unmet need for electrochromic materials that have high coloration efficiency, faster switching time, and ability to integrate with transparent electronic conductors, chemically and structurally compatible with broad selection of liquid and solid phase electrolytes, industrially scalable fabrication methods, broad response to the solar spectrum and greater durability.

### SUMMARY

An electrochromic system is disclosed which includes a first glass layer having a bottom side and a top side, the top side is coated with a first transparent conductor layer, an electrolyte layer formed adjacent to the first transparent conductor layer, an electrochromic layer formed adjacent to the electrolyte layer, and a second glass layer having a top side and a bottom side, the bottom side coated with a second transparent conductor layer and coupled to the electrochromic layer.

In the electrochromic system, the first and second transparent conductor layers each have a thickness ranging from about 10 nm to about 200 nm.

In the electrochromic system, the first and second transparent conductor layers include material selected from the group consisting of fluorine doped tin oxide (FTO), indium doped tin oxide (ITO) coated glass or plastic, and a combination thereof.

In the electrochromic system of claim 1, the electrochromic layer has a thickness from about 5 nm to about 500 nm.

In the electrochromic system, the electrochromic layer includes lanthanide nickelates.

In the electrochromic system, the electrochromic layer includes material selected from the group consisting of Samarium nickelate (SmNiO₃), neodymium nickelate (NdNiO₃), europium nickelate (EuNiO₃), and alloys thereof.

In the electrochromic system, the electrolyte layer has a thickness from about 10 nm to about 5 mm.

In the electrochromic system, the electrolyte layer includes material selected from the group consisting of sodium chloride aqueous solution (NaCl in H₂O), lithium perchlorate in ethylene carbonate, and a combination thereof.

Another electrochromic system is disclosed which includes a first glass layer having a bottom side and a top side, the top side coated with a first transparent conductor layer, a second electrochromic layer formed adjacent to the first transparent conductor layer, an ion-storage layer formed adjacent to the second electrochromic layer, an electrolyte layer formed adjacent to the ion-storage layer, a first electrochromic layer formed adjacent to the electrolyte layer, and a second glass layer having a top side and a bottom side, the bottom side coated with a second transparent conductor layer and coupled to the first electrochromic layer.

In the electrochromic system, the first and second transparent conductor layers each have a thickness ranging from about 10 nm to about 200 nm.

In the electrochromic system, the first and second transparent conductor layers include material selected from the group consisting of fluorine doped tin oxide (FTO), indium doped tin oxide (ITO) coated glass or plastic, and a combination thereof.

In the electrochromic system, the first and second electrochromic layers each has a thickness from about 5 nm to about 500 nm.

In the electrochromic system, the first and second electrochromic layers each includes lanthanide nickelates.

In the electrochromic system, the first and second electrochromic layers each includes material selected from the group consisting of Samarium nickelate (SmNiO₃), neodymium nickelate (NdNiO₃), europium nickelate (EuNiO₃), and alloys thereof.

In the electrochromic system, the electrolyte layer has a thickness from about 10 nm to about 5 mm.

In the electrochromic system, the electrolyte layer includes material selected from the group consisting of sodium chloride aqueous solution (NaCl in H₂O), lithium perchlorate in ethylene carbonate, and a combination thereof.

In the electrochromic system, the ion-storage layer has a thickness from about 5 nm to about 500 nm.

In the electrochromic system, the ion-storage layer includes tungsten oxide.

An electrochromic system, comprising:

a first glass layer having a bottom side and a top side, the top side coated with a first transparent conductor layer;
a second electrochromic layer formed adjacent to the first transparent conductor layer;
an electrolyte layer formed adjacent to the second electrochromic layer,
a first electrochromic layer formed adjacent to the electrolyte layer, and
a second glass layer having a top side and a bottom side, the bottom side coated with a second transparent conductor layer and coupled to the first electrochromic layer.

In the electrochromic system, the first and second transparent conductor layers each have a thickness ranging from about 10 nm to about 200 nm.

In the electrochromic system, the first and second transparent conductor layers include material selected from the group consisting of fluorine doped tin oxide (FTO), indium doped tin oxide (ITO) coated glass or plastic, and a combination thereof.

In the electrochromic system, the first and second electrochromic layers each has a thickness from about 5 nm to about 500 nm.

In the electrochromic system, the first and second electrochromic layers each includes lanthanide nickelates.

In the electrochromic system, the first and second electrochromic layers each includes material selected from the group consisting of Samarium nickelate (SmNiO₃), neodymium nickelate (NdNiO₃), europium nickelate (EuNiO₃), and alloys thereof.

In the electrochromic system, the electrolyte layer has a thickness from about 10 nm to about 5 mm.

In the electrochromic system, the electrolyte layer includes material selected from the group consisting of sodium chloride aqueous solution (NaCl in H₂O), lithium perchlorate in ethylene carbonate, and a combination thereof.

An electrochromic system, comprising:

a first glass layer having a bottom side and a top side, the top side coated with a first transparent conductor layer;
an electrochromic layer formed adjacent to the first transparent conductor layer;
a conductor disposed on the electrochromic layer, the conductor configured to provide electrical connectivity to the electrochromic layer;
an ion-storage layer formed adjacent to the electrochromic layer;
an electrolyte layer formed adjacent to the ion-storage layer; and
a second glass layer having a top side and a bottom side, the bottom side coated with a second transparent conductor layer and coupled to the electrolyte layer.

In the electrochromic system, the first and second transparent conductor layers each have a thickness ranging from about 10 nm to about 200 nm.

In the electrochromic system, the first and second transparent conductor layers include material selected from the group consisting of fluorine doped tin oxide (FTO), indium doped tin oxide (ITO) coated glass or plastic, and a combination thereof.

In the electrochromic system, the electrochromic layer has a thickness from about 5 nm to about 500 nm.

In the electrochromic system, the electrochromic layer includes lanthanide nickelates.

In the electrochromic system, the electrochromic layer includes material selected from the group consisting of Samarium nickelate (SmNiO₃), neodymium nickelate (NdNiO₃), europium nickelate (EuNiO₃), and alloys thereof.

In the electrochromic system, the electrolyte layer has a thickness from about 10 nm to about 5 mm.

In the electrochromic system, the electrolyte layer includes material selected from the group consisting of sodium chloride aqueous solution (NaCl in H₂O), lithium perchlorate in ethylene carbonate, and a combination thereof.

In the electrochromic system, the ion-storage layer has a thickness from about 5 nm to about 500 nm.

In the electrochromic system, the ion-storage layer includes tungsten oxide.

In the electrochromic system, the conductor has a thickness in the range of 5 nm to 200 nm.

In the electrochromic system, the conductor includes material selected from the group consisting of ITO, FTO, platinum, silver, and a combination thereof.

### BRIEF DESCRIPTION OF THE FIGURES

Some of the figures shown herein may include dimensions. Further, some of the figures shown herein may have been created from scaled drawings or from photographs that are scalable. It is understood that such dimensions or the relative scaling within a figure are by way of example, and not to be construed as limiting. It should be recognized that all the figures shown are not to scale.

FIG. 1 shows a smart window configuration of the present disclosure, including first and second glass layer (one can be a mirror), first and second transparent conductor layers, an ion storage layer, an electrolyte layer, and an electrochromic layer.

FIG. 2 shows a second embodiment of a smart window configuration according to the present disclosure which is similar to the embodiment of FIG. 1 but without an ion storage layer.

FIG. 3 shows a third embodiment of a smart window configuration according to the present disclosure which is similar to the embodiment of FIG. 1 but with two electrochromic layers.

FIG. 4 shows a fourth embodiment of a smart window configuration according to the present disclosure which is similar to the embodiment of FIG. 3 but with an ion storage layer.

FIG. 5 shows a fifth embodiment of a smart window configuration according to the present disclosure which is similar to the embodiment of FIG. 1 but wherein a part of the electrochromic layer is coated with conductor.

FIGS. 6A and 6B show images of electrochromic smart window configuration (FTO coated glass/NdNiO₃/NaCl solution/FTO coated glass, according to one embodiment of the present disclosure) in the colored (+3.0 V), FIG. 6A, and bleached (−3.0 V), FIG. 6B, states respectively.

FIGS. 7A and 7B show images of electrochromic window (FTO coated glass/NdNiO₃/NaCl solution/FTO coated glass, according to one embodiment of the present disclosure) in the colored (+2.0 V), FIG. 7A, and bleached (−2.0 V), FIG. 7B, states.

FIGS. 8A though 8C show another set of results of actual reduction to practice according to the present disclosure, and illustrate transparency control by the use of an NNO thin film in the multi-layer materials systems of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the present disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

In response to the unmet need, the present disclosure describes new perovskite nickelate electrochromic-based stacks with properties suitable for several optical systems including, but not limited to smart windows and smart mirrors (collectively Smart Windows). Smart Windows utilizing these stacks can dynamically and rapidly modulate the optical transmittance in response to electrical stimuli, which advantageously provides an opportunity to enhance the performance of Smart Windows.

The nickelate electrochromic thin film of the present disclosure can be prepared by diverse vapor deposition technologies including sputtering (PVD), pulsed laser deposition (PLD), molecular beam epitaxy (MBE), atomic layer deposition (ALD) and other vacuum evaporation processes known to a person having ordinary skill in the art on a substrate. In addition, according to another embodiment, the nickelate electrochromic material of the present disclosure can be spray painted or tape cast followed by annealing, as appropriate.

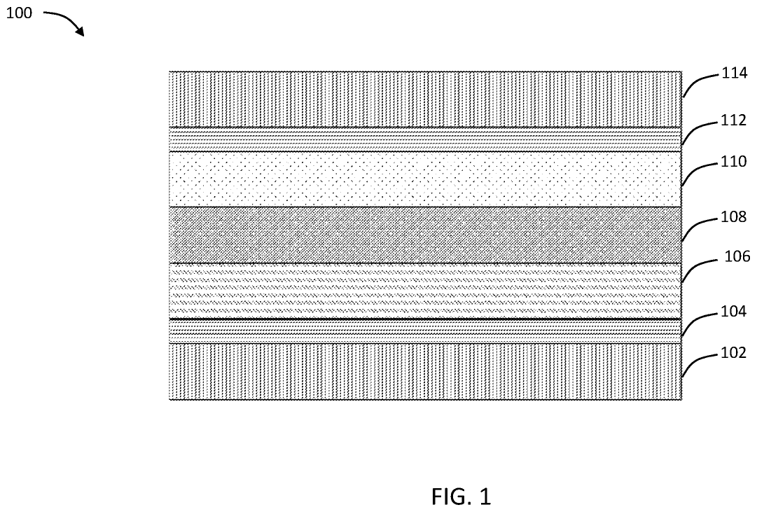

The design of Smart Windows based on nickelate electrochromic layer shown in the present disclosure can be realized, for example, in a multiple layer configuration. It should be noted that the thicknesses of any of the layers shown in FIGS. 1-5, described below are solely for the purpose of demonstration and thus no limitations shall be construed from their relative dimensions. Referring to FIG. 1, a first embodiment of the Smart Window 100 (thickness ranging from about 100 μm to about 50 mm) is provided, according to the present disclosure. The Smart Window 100 includes several layers: a first glass layer 102 with one side coated with a first transparent conductor layer 104, an ion-storage layer 106, an ionic conductor layer functioning as an electrolyte layer 108, an electrochromic layer 110, and a second glass layer 114 with one side coated with a second transparent conductor layer 112, all stacked in layers in the order as shown in FIG. 1. Referring to FIG. 1, the first and second transparent conductor layers 104 and 112 each have a thickness ranging from about 10 nm to about 200 nm and can be made of materials such as, but not limited to, fluorine doped tin oxide (FTO) or indium doped tin oxide (ITO) coated glass or plastic. The electrolyte layer 108 shown in FIG. 1 can be a transparent liquid ionic conductor such as but not limited to sodium chloride aqueous solution (NaCl in H₂O) or lithium perchlorate in ethylene carbonate (EC), i.e., LiClO₄ in EC. The electrolyte layer 108 can also be made of a transparent ionic conducting gel and solid ionic conductor, such as but not limited to poly(ethylene oxide) (PEO) infiltrated LiClO₄. The electrolyte layer 108 is insulating for electronic currents, however, allows ions to pass through. Typical thickness of the electrolyte layer 108 is in the range of between about 10 nm to about 5 mm. The electrochromic layer 110 shown in FIG. 1 can range in thickness from about 5 nm to about 500 nm and can be made of be one of lanthanide nickelates including but not limited to SmNiO₃ (SNO), NdNiO₃ (NNO) or EuNiO₃ (ENO) or their alloys, heterostructures and nanoparticles of such chromic materials. The ion storage layer 106 show in FIG. 1 functions as a counter electrode vs. the electrochromic layer 110 and has a typical thickness range of about 5 nm to about 500 nm. Materials suitable as an ion storage layer 106 include, but not limited to tungsten oxide (WO₃). In the present disclosure, as mentioned above neodymium nickel oxide (NdNiO₃) is also referred to as NNO.

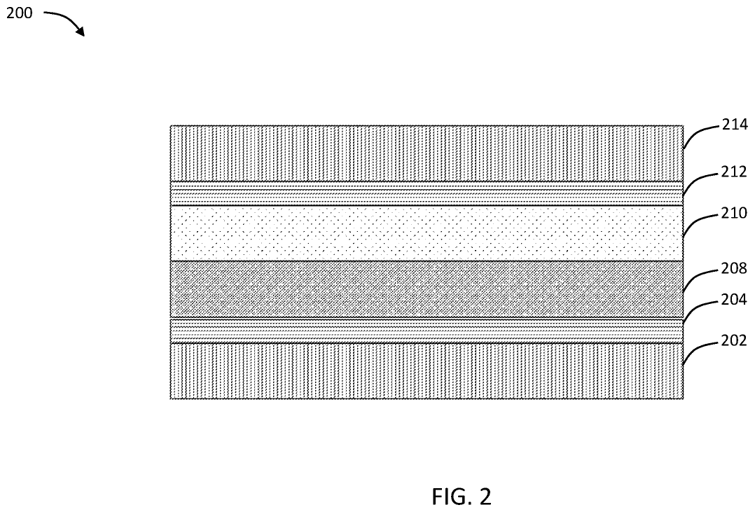

Referring to FIG. 2, a second embodiment of a Smart Window 200 according to the present disclosure is provided which is similar to the Smart Window system 100 of FIG. 1 but without an ion storage layer 106. The Smart Window system 200 includes several layers: a first glass layer 202 with one side coated with a first transparent conductor layer 204, an ionic conductor layer functioning as an electrolyte layer 208, an electrochromic layer 210, and a second glass layer 214 with one side coated with a second transparent conductor layer 212, all stacked in layers in the order as shown in FIG. 2. Referring to FIG. 2, the first and second transparent conductor layers 204 and 212 each have a thickness ranging from about 10 nm to about 200 nm and can be made of materials such as, but not limited to, FTO or ITO coated glass or plastic. The electrolyte layer 208 shown in FIG. 2 can be a transparent liquid ionic conductor such as but not limited to NaCl solution in H₂O or LiClO₄ in EC. The electrolyte layer 208 can also be made of a transparent ionic conducting gel and solid ionic conductor, such as but not limited to PEO infiltrated LiClO₄. The electrolyte layer 208 is insulating for electronic currents, however, allows ions to pass through. Typical thickness of the electrolyte layer 208 is in the range of between about 10 nm to about 5 mm. The electrochromic layer 210 shown in FIG. 2 can range in thickness from about 5 nm to about 500 nm and can be made of be one of lanthanide nickelates including but not limited to SmNiO₃ (SNO), NdNiO₃ (NNO) or EuNiO₃ (ENO) or their alloys, heterostructures and nanoparticles of such chromic materials. With reference to FIG. 2, the second transparent conductor layer 212 can additionally function as ion storage layer as well. Materials for the layers and layer thicknesses are similar and can be inferred from the description of the embodiment shown in FIG. 1 above Eliminating the need for an additional layer can simplify the design and reduce manufacturing costs. As such, the second transparent conductor layer 212 functions as a counter electrode vs. the electrochromic layer 210.

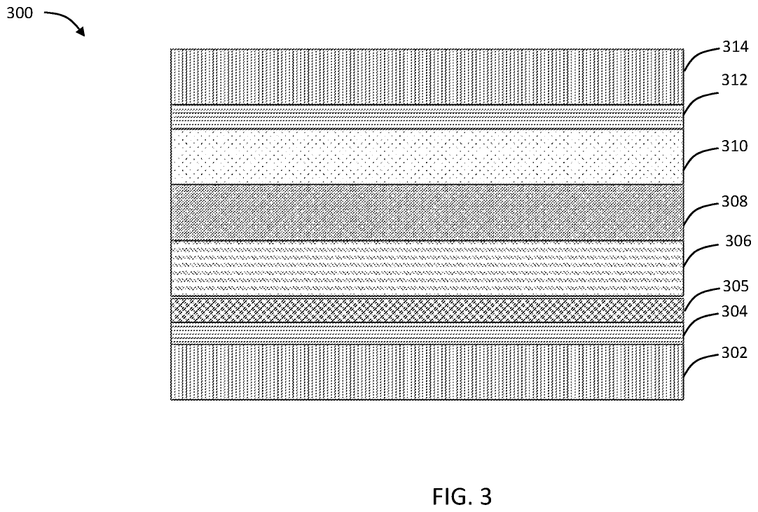

Referring to FIG. 3, a third embodiment of a Smart Window 300 according to the present disclosure is provided which is similar to the Smart Window system 100 of FIG. 1 but which has a second electrochromic layer 305. Referring to FIG. 3, the third embodiment of the Smart Window 300 with a thickness ranging from about 100 μm to about 50 mm is provided, according to the present disclosure. The Smart Window 300 includes several layers: a first glass layer 302 with one side coated with a first transparent conductor layer 304, a second electrochromic layer 305, an ion-storage layer 306, an ionic conductor layer functioning as an electrolyte layer 308, a first electrochromic layer 310, and a second glass layer 314 with one side coated with a second transparent conductor layer 312, all stacked in layers in the order as shown in FIG. 3. Referring to FIG. 3, the first and second transparent conductor layers 304 and 312 each have a thickness ranging from about 10 nm to about 200 nm and can be made of materials such as, but not limited to, FTO or ITO coated glass or plastic. The electrolyte layer 308 shown in FIG. 3 can be a transparent liquid ionic conductor such as but not limited to NaCl solution in H₂O or LiClO₄ in EC. The electrolyte layer 308 can also be made of a transparent ionic conducting gel and solid ionic conductor, such as but not limited to PEO infiltrated LiClO₄. The electrolyte layer 308 is insulating for electronic currents, however, allows ions to pass through. Typical thickness of the electrolyte layer 308 is in the range of between about 10 nm to about 5 mm. The first and second electrochromic layers 310 and 305 shown in FIG. 3 can range in thickness from about 5 nm to about 500 nm and can be made of be one of lanthanide nickelates including but not limited to SmNiO₃ (SNO), NdNiO₃ (NNO) or EuNiO₃ (ENO) or their alloys, heterostructures and nanoparticles of such chromic materials. The ion storage layer 306 show in FIG. 3 functions as a counter electrode for electron balancing vs. the first and second electrochromic layers 310 and 305 and has a typical thickness range of about 5 nm to about 500 nm. Materials suitable as an ion storage layer 306 include, but not limited to WO₃. The Smart Window system 300 of the present disclosure provides additional control over coloration, as needed. The choice of the two electrochromic layers 310 and 305 allows for the additional control. One of the electrochromic layers 310 or 305 is chosen such that when electrons are added to it, the associated electrochromic layer (310 or 305) becomes more opaque. The second electrochromic layer of the two electrochromic layers 310 and 305 is chosen such that when electrons leave it, the associated electrochromic layer (310 or 305) becomes more opaque. Therefore, in this configuration for an applied electrical bias, both layers will become more opaque making the Smart Window system 300 appear darker, and when the reverse electrical bias is applied, both become less opaque (i.e., more transparent), increasing the contrast ratio between transparent and dark states. For one application of the Smart Window system 300, one of the two electrochromic layers 310 and 305 may include WO₃ while the other may include NdNiO₃. When Li or other small ions leave NdNiO₃ and move to WO₃ under an electric bias, NdNiO₃ becomes dark (as it becomes more conducting when ions leave the lattice) while WO₃ also becomes dark (as it becomes more conducting when ions enter the lattice). This contrast can be used synergistically for various types of applications.

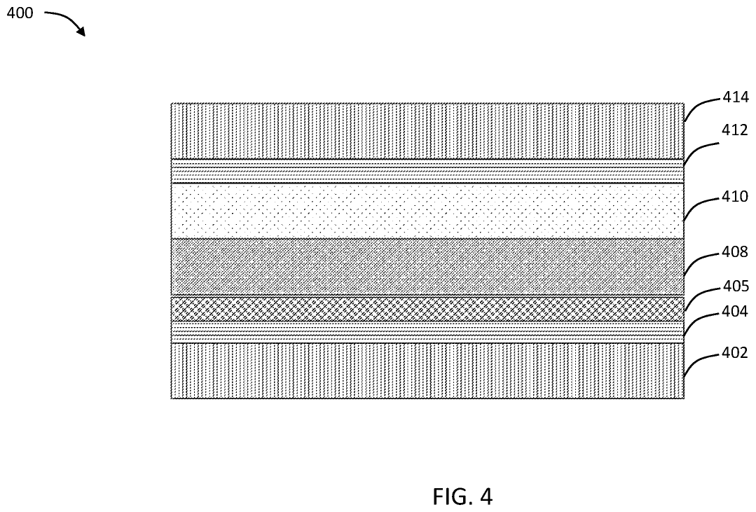

Referring to FIG. 4, yet another embodiment of a Smart Window 400 is shown, according to the present disclosure, including two electrochromic layers 405 and 410 but without an ion storage layer (see ion storage layer 306 of FIG. 3). Referring to FIG. 4, the fourth embodiment of the Smart Window 400 with a thickness ranging from about 100 μm to about 50 mm is provided, according to the present disclosure. The Smart Window 400 includes several layers: a first glass layer 402 with one side coated with a first transparent conductor layer 404, a second electrochromic layer 405, an ionic conductor layer functioning as an electrolyte layer 408, a first electrochromic layer 410, and a second glass layer 414 with one side coated with a second transparent conductor layer 412, all stacked in layers in the order as shown in FIG. 4. Referring to FIG. 4, the first and second transparent conductor layers 404 and 412 each have a thickness ranging from about 10 nm to about 200 nm and can be made of materials such as, but not limited to, FTO or ITO coated glass or plastic. The electrolyte layer 408 shown in FIG. 4 can be a transparent liquid ionic conductor such as but not limited to NaCl solution in H₂O or LiClO₄ in EC. The electrolyte layer 308 can also be made of a transparent ionic conducting gel and solid ionic conductor, such as but not limited to PEO infiltrated LiClO₄. The electrolyte layer 408 is insulating for electronic currents, however, allows ions to pass through. Typical thickness of the electrolyte layer 408 is in the range of between about 10 nm to about 5 mm. The first and second electrochromic layers 410 and 405 shown in FIG. 4 can range in thickness from about 5 nm to about 500 nm and can be made of be one of lanthanide nickelates including but not limited to SmNiO₃ (SNO), NdNiO₃ (NNO) or EuNiO₃ (ENO) or their alloys, heterostructures and nanoparticles of such chromic materials. The Smart Window system 400 of the present disclosure provides additional control over coloration, as needed. The choice of the two electrochromic layers 410 and 405 allows for the additional control. One of the electrochromic layers 410 or 405 is chosen such that when electrons are added to it, the associated electrochromic layer (410 or 405) becomes more opaque. The second electrochromic layer of the two electrochromic layers 410 and 405 is chosen such that when electrons leave it, the associated electrochromic layer (410 or 405) becomes more opaque. Therefore, in this configuration for an applied electrical bias, both layers will become more opaque making the Smart Window system 400 appear darker, and when the reverse electrical bias is applied, both become less opaque (i.e., more transparent), increasing the contrast ratio between transparent and dark states. For one application of the Smart Window system 400, one of the two electrochromic layers 410 and 405 may include WO₃ while the other may include NdNiO₃. When Li or other small ions leave NdNiO₃ and move to WO₃ under an electric bias, NdNiO₃ becomes dark (as it becomes more conducting when ions leave the lattice) while WO₃ also becomes dark (as it becomes more conducting when ions enter the lattice). This contrast can be used synergistically for various types of applications.

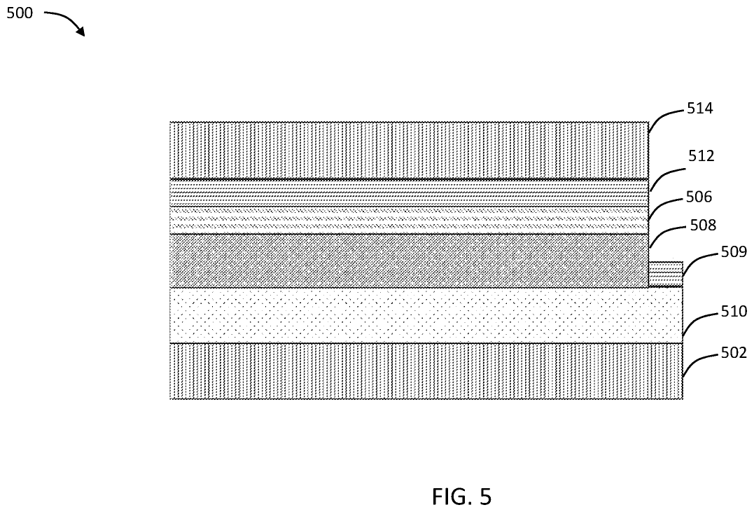

Referring to FIG. 5, a fifth embodiment of the present disclosure as a Smart Window system 500 is provided according to the present disclosure. The main difference between the Smart Window system 500 and any of the other embodiments is that a part of the electrochromic layer 510 is coated with an electronic conductor 509. The Smart Window system 500 includes several layers: a first glass layer 502, an electrochromic layer 510, a conductor disposed on a portion of the electrochromic layer 510, an ionic conductor layer functioning as an electrolyte layer 508, an ion storage layer 506, and a second glass layer 514 with one side coated with a transparent conductor layer 512, all stacked in layers in the order as shown in FIG. 5. Referring to FIG. 5, the transparent conductor layer 212 has a thickness ranging from about 10 nm to about 200 nm and can be made of materials such as, but not limited to, FTO or ITO coated glass or plastic. The electrolyte layer 508 shown in FIG. 5 can be a transparent liquid ionic conductor such as but not limited to NaCl solution in H₂O or LiClO₄ in EC. The electrolyte layer 508 can also be made of a transparent ionic conducting gel and solid ionic conductor, such as but not limited to PEO infiltrated LiClO₄. The electrolyte layer 508 is insulating for electronic currents, however, allows ions to pass through. Typical thickness of the electrolyte layer 508 is in the range of between about 10 nm to about 5 mm. The electrochromic layer 510 shown in FIG. 5 can range in thickness from about 5 nm to about 500 nm and can be made of be one of lanthanide nickelates including but not limited to SmNiO₃ (SNO), NdNiO₃ (NNO) or EuNiO₃ (ENO) or their alloys, heterostructures and nanoparticles of such chromic materials. Referring to FIG. 5, this configuration is a modification of the embodiment shown in FIG. 1 in that part of the electrochromic layer 510 has an electronic conducting layer coated thereon while the rest of the electrochromic layer 510 is covered by the electrolyte layer 508. Further, in the fifth embodiment, shown in FIG. 5, there is no transparent conductor layer between the electrochromic layer 510 and the first glass layer 502, unlike what is shown in FIG. 1. The conductor 509 serves as a counter electrode and can be used to provide electrical energy to drive ions in and out of the electrochromic layer 510. In this configuration, the electrochromic layer can be directly deposited on glass or some other transparent surface and avoid the need for another thin film layer in between. This change simplifies the structure of the device for manufacturing and increases the choice of electrodes that can be used at the device edges such as elemental metals. The electrodes can be made along all the edges or corners of the device, as their main purpose is to supply electric bias and do not need to be optically transparent necessarily. Materials and thickness considerations for these layers are similar as described above with reference to FIG. 1. The conductor 509 has a thickness in the range of about 5 nm to about 200 nm and can be made of materials such as, but not limited to ITO, FTO, platinum, silver, and other suitable material known to a person having ordinary skill in the art. Methods of effecting such coatings (including sputtering, e-beam evaporation, spin-coating, etc.) are known to those skilled in the art. In this embodiment, the materials of conducting layer could have more options, which facilitate the material feasibility of the entire Smart Window.

In all the embodiments described above, in use, an electrical bias is applied across the first and second conducting layer (Smart Window system 500 shown in FIG. 5 is different as the electrical bias is applied across the conductor 509 and the transparent conductor layer). Operations of the multilayer configuration of the present disclosure are readily apparent to those skilled in the art.

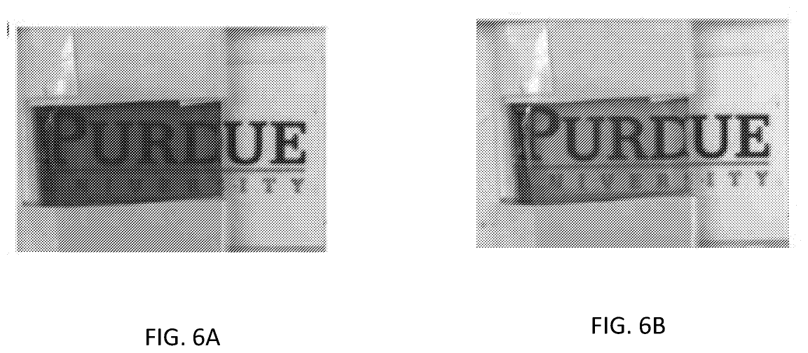

FIGS. 6A and 6B show images of electrochromic Smart Window configuration (FTO coated glass/NdNiO₃/NaCl solution/FTO coated glass) according to the second embodiment as shown in FIG. 2 in the colored (+3.0 V) and bleached (−3.0 V) states respectively. Referring to FIGS. 6A and 6B, the nickelate electrochromic layers exhibited uniform coloration and bleaching within the same window architecture. The response times for coloring and bleaching were all less than is when powered by batteries.

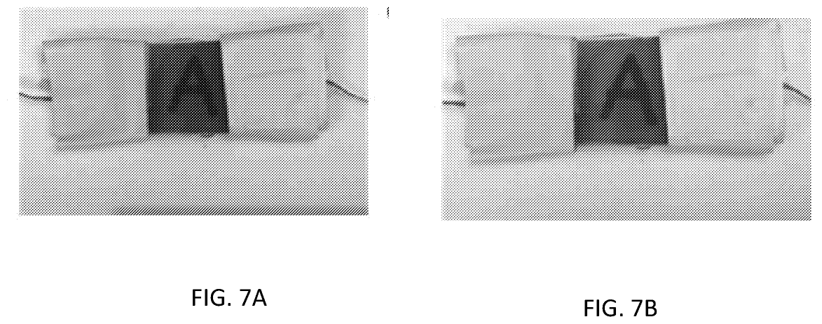

FIGS. 7A and 7B show images of electrochromic window (FTO coated glass/NdNiO₃/NaCl solution/FTO coated glass) in the colored (+2.0 V), FIG. 7A, and bleached (−2.0 V), FIG. 7B, states according to the second embodiment as shown in FIG. 2. Referring to FIGS. 7A and 7B, it can be seen that color of this Smart Window configuration can be switched between dark and transparent state at 2.0 V for 30 s. In stability measurements, the device showed stability for at least 50 cycles.

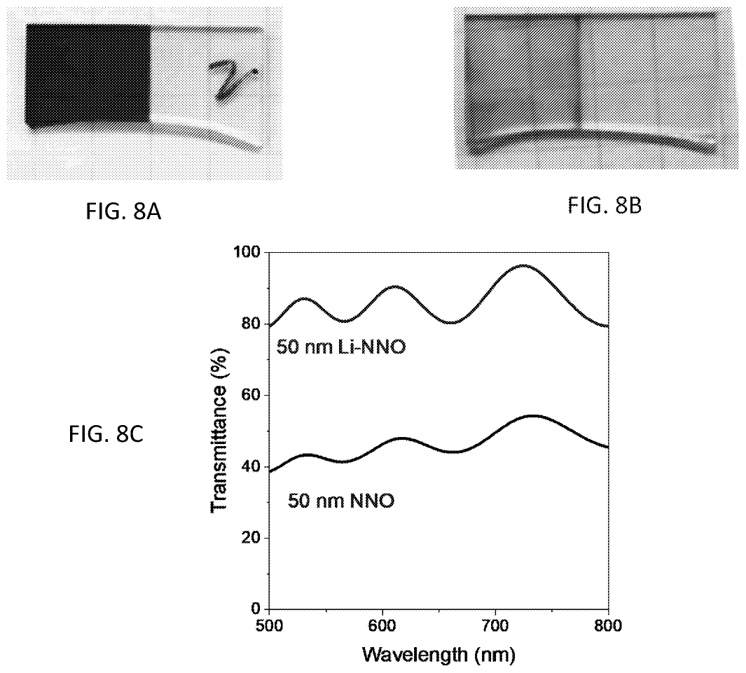

FIGS. 8A though 8C show another set of results of experimental work leading to the present disclosure, and illustrate transparency control by the use of an NNO thin film in the multi-layer materials systems of the present disclosure according to the second embodiment as shown in FIG. 2. Referring to FIG. 8A, an optical image of pristine 50 nm thick NNO thin film on transparent coated conductor grown on glass. The film is opaque. FIG. 8B shows an optical image of Li-doped NNO thin film, demonstrating that the film becomes transparent after Li-doping. FIG. 8C shows the normalized transmittance spectra (wavelength from 500 nm to 800 nm) of pristine un-doped NNO and Li—NNO. The transmittance of NNO is around 50%. After doping, the transmittance of Li—NNO increased to around 90%. The change in transmittance and the switching speed can be controlled and optimized for specific applications by electrochromic material thickness, electrode spacing, electrolyte etc.

Based on the above description, it is an objective of the present disclosure to describe an optical materials system containing an electrochromic layer overlaying and in contact with an electrolyte layer, wherein the electrical resistivity of the electrochromic layer increase with increase in ion transfer occurring in response to an applied voltage across the electrolyte.

It is another objective of the present disclosure to describe an apparatus containing a first transparent glass layer, a first transparent conductor layer overlaying and in contact with the first glass layer, a transparent electrolyte layer overlaying and in contact with the transparent conductor layer, an electrochromic layer overlaying and in contact with the electrolyte layer; a second transparent conductor layer overlaying and in contact with the electrochromic layer; and a second glass layer overlaying and in contact with the second transparent conductor layer, wherein the electrical resistivity of the electrochromic layer increase with increase in ion transfer occurring in response to an applied voltage across the electrolyte. In some embodiments of this apparatus, there can be an additional or second electrochromic layer in between and in contact with the electrolyte layer and the first transparent conductor layer. In some other embodiments of the systems of the present disclosure, there can be a distinct ion storage layer in between and in contact with the electrolyte layer and the first transparent conductor layer. In some embodiments of the systems of the present disclosure there can be a second electrochromic layer overlaying and in contact with the first transparent conductor layer and the ion storage layer.

It is yet another objective of the present disclosure to describe an optical materials system containing a first transparent glass layer, an electrochromic layer overlaying and in contact with the first transparent glass layer, a conductor layer overlaying and in contact with the electrochromic layer, and partially covering with the electrochromic layer, a transparent electrolyte layer and in contact with the electrochromic layer, and partially covering with the electrochromic layer, an ion-storage layer overlaying and in contact with transparent electrolyte layer, a second transparent conductor layer overlaying and in contact with the electrochromic layer, and second glass layer overlaying and in contact with the second transparent conductor layer, wherein the electrical resistivity of the electrochromic layer increase with increase in ion transfer occurring in response to an applied voltage across the electrolyte.

A non-limiting example for the material for the first transparent glass layer and the second transparent glass layer is quartz. Non-limiting examples for the materials from which the first and second transparent conductors can be made from are FTO or ITO. A non-limiting example of the transparent electrolyte layer is NaCl solution in H₂O or LiClO₄ in EC. Materials suitable for the first and second electrochromic layer include lanthanide nickelates such as but not limited to SmNiO₃ (SNO), NdNiO₃ (NNO) and EuNiO₃ (ENO). A non-limiting example for the material for the ion storage layer is WO₃.

It is another objective of the present disclosure to describe a method of making optical materials systems capable of transmission control. The intended method is described above and many variations of the method will be evident to those skilled din the art.

These Smart Window configurations of the present disclosure could find broad applications in smart windows for the large-scale deployment of electrochromic windows, energy savings, and tunable optical elements such as light shutters for eyewear, personnel protection, tunable emissivity layers, electromagnetic and other radiation shielding applications and so forth.

The fabrication of a multi-layer configuration as shown in FIG. 2 of the present disclosure will now be described as an example of fabrication steps. Fabrication of the embodiment shown in FIG. 2 will now be described. Those skilled in the art can infer, from this description, fabrication of the other embodiments described in the present disclosure, and similar embodiments not specifically described in the present disclosure. In the experiments leading to the present disclosure, the following steps were utilized in fabricating the configuration shown in FIG. 2:
Step. 1: The neodymium nickelate (NNO) electrochromic thin film (about 50 nm) (electrochromic layer) was deposited on FTO (thickness: about 180 nm, second transparent conductor) coated glass (1.5 cm*1 cm*2 mm, second glass layer) substrate by magnetron sputtering technology using metallic Nd and metallic Ni as targets. The typical deposition condition was the mixture gas of 40 sccm Ar and 10 sccm O₂ at gas pressure of 5 mtorr at room temperature (25° C.). One typical sputtering power of Nd and Ni targets are 170 Watt and 65 Watt, respectively. 20 minutes deposition time can offer the film thickness of about 50 nm. The as-deposited nickelate should be annealed in air at high temperature (about 500° C.) for a period of time (about 24 hours) to get high crystallinity.
Step. 2: For the preparation of electrolyte solution (e.g., NaCl aqueous solution), we first used balance to weigh 0.1 mol of sodium chloride salt. And then, the salt was added to and dissolved in 100 ml de-ionized water in the beaker. The solution was continuously stirred using magnetic stirrer at room temperature until the solution is clear and no solid is visible within the solution. The concentration of the electrolyte was 1 M.
Step. 3: A bare FTO (about 180 nm in thickness, first transparent conductor layer) coated glass (1.5 cm*1 cm*2 mm, first glass layer) that served as the counter electrode and connected with copper wire and stick well with rubber tape.
Step. 4: Another copper wire was contacted well with the bare FTO area of working electrode and stick well with rubber tape as well.
Step. 5: The two electrodes were assembled using rubber tape on both sides (where wire connected), leaving a space between them and avoiding direct contact.
Step. 6: The electrolyte solution was injected into the space mentioned in step 6 by a syringe until whole area was covered by solution and no visible bubble is observed.
Step. 7: Sealing the fourth side with epoxy glue gave us the final electrochromic device.

In the embodiments of the present disclosure, a non-limiting choice for the electrochromic layer is perovskite nickelate, also referred to as the nickelate in the present disclosure, for the sake of simplicity. The basic working mechanism of the nickelate electrochromic layer of the present disclosure involves reversible cation migration across the electrochromic layer. Under bias, the electron configuration of orbital of nickel ion in nickelate could be modified by injecting an extra electron along with cation insertion into nickelate lattice. The nickelate undergoes an electron filling induced phase transition and forms a strongly correlated insulating system and becomes optically transparent. Consequently, when cations insert into nickelate electrochromic layer, the window is under bleaching process due to enlarged optical band gap. The film maintains its state until the voltage is reversed (coloring), causing cation moving out, narrowing optical band gap, and effectively turning windows opaque. The windows are non-volatile. That is the transparency can be maintained without continuous power supply. Similar arguments hold for the choice of second chromic layer in some of the embodiments discussed above. Materials like WO₃ change color when small ions such as protons or lithium are inserted as the electronic configuration of the W ion is modified. Adding dopants such as protons makes the tungsten trioxide more conducting and therefore darker. Hence, they can be integrated synergistically with the perovskite nickelates in multilayer electrochromic window technologies.

The above result is possible due to the unique fact that the electrical resistivity of the NNO electrochromic layer of the present disclosure increases with increase in ion intercalated occurring in response to an applied voltage across the electrolyte. This is dramatically different from traditional electrochromic material such as WO₃ where adding electrons to the conduction band results in the material becoming metallic. Further, since we are able to access very large value of the effective gap in the nickelate ranging over 3 eV, we can be responsive to broadband radiation and large range in transmissivity.

Those skilled in the art will recognize that numerous modifications can be made to the specific implementations described above. The implementations should not be limited to the particular limitations described. Other implementations may be possible.

1. An electrochromic system, comprising:
a first glass layer having a bottom side and a top side, the top side coated with a first transparent conductor layer;
an electrolyte layer formed adjacent to the first transparent conductor layer;
an electrochromic layer formed adjacent to the electrolyte layer; and
a second glass layer having a top side and a bottom side, the bottom side coated with a second transparent conductor layer and coupled to the electrochromic layer.

2. The electrochromic system of claim 1, wherein the first and second transparent conductor layers each have a thickness ranging from about 10 nm to about 200 nm.

3. The electrochromic system of claim 2, wherein the first and second transparent conductor layers include material selected from the group consisting of fluorine doped tin oxide (FTO), indium doped tin oxide (ITO) coated glass or plastic, and a combination thereof.

4. The electrochromic system of claim 1, wherein the electrochromic layer has a thickness from about 5 nm to about 500 nm

5. The electrochromic system of claim 4, wherein the electrochromic layer includes lanthanide nickelates.

6. The electrochromic system of claim 5, wherein the electrochromic layer includes material selected from the group consisting of Samarium nickelate (SmNiO₃), neodymium nickelate (NdNiO₃), europium nickelate (EuNiO₃), and alloys thereof.

7. (canceled)

8. The electrochromic system of claim 1, wherein the electrolyte layer includes material selected from the group consisting of sodium chloride aqueous solution (NaCl in H₂O), lithium perchlorate in ethylene carbonate, and a combination thereof.

9. An electrochromic system, comprising:
a first glass layer having a bottom side and a top side, the top side coated with a first transparent conductor layer;
a second electrochromic layer formed adjacent to the first transparent conductor layer;
an ion-storage layer formed adjacent to the second electrochromic layer;
an electrolyte layer formed adjacent to the ion-storage layer;
a first electrochromic layer formed adjacent to the electrolyte layer; and
a second glass layer having a top side and a bottom side, the bottom side coated with a second transparent conductor layer and coupled to the first electrochromic layer.

10. The electrochromic system of claim 9, wherein the first and second transparent conductor layers each have a thickness ranging from about 10 nm to about 200 nm.

11. The electrochromic system of claim 10, wherein the first and second transparent conductor layers include material selected from the group consisting of fluorine doped tin oxide (FTO), indium doped tin oxide (ITO) coated glass or plastic, and a combination thereof.

12. The electrochromic system of claim 9, wherein the first and second electrochromic layers each has a thickness from about 5 nm to about 500 nm.

13. The electrochromic system of claim 12, wherein the first and second electrochromic layers each includes lanthanide nickelates.

14. The electrochromic system of claim 13, wherein the first and second electrochromic layers each includes material selected from the group consisting of Samarium nickelate (SmNiO₃), neodymium nickelate (NdNiO₃), europium nickelate (EuNiO₃), and alloys thereof.

15. (canceled)

16. The electrochromic system of claim 9, wherein the electrolyte layer includes material selected from the group consisting of sodium chloride aqueous solution (NaCl in H₂O), lithium perchlorate in ethylene carbonate, and a combination thereof.

17. (canceled)

18. The electrochromic system of claim 9, wherein the ion-storage layer includes tungsten oxide.

19. An electrochromic system, comprising:
a first glass layer having a bottom side and a top side, the top side coated with a first transparent conductor layer;
a second electrochromic layer formed adjacent to the first transparent conductor layer;
an electrolyte layer formed adjacent to the second electrochromic layer;
a first electrochromic layer formed adjacent to the electrolyte layer; and
a second glass layer having a top side and a bottom side, the bottom side coated with a second transparent conductor layer and coupled to the first electrochromic layer.

20. (canceled)

21. The electrochromic system of claim 19, wherein the first and second transparent conductor layers include material selected from the group consisting of fluorine doped tin oxide (FTO), indium doped tin oxide (ITO) coated glass or plastic, and a combination thereof.

22. (canceled)

23. The electrochromic system of claim 19, wherein the first and second electrochromic layers each includes lanthanide nickelates.

24. The electrochromic system of claim 23, wherein the first and second electrochromic layers each includes material selected from the group consisting of Samarium nickelate (SmNiO₃), neodymium nickelate (NdNiO₃), europium nickelate (EuNiO₃), and alloys thereof.

25. (canceled)

26. The electrochromic system of claim 19, wherein the electrolyte layer includes material selected from the group consisting of sodium chloride aqueous solution (NaCl in H₂O), lithium perchlorate in ethylene carbonate, and a combination thereof.

27-38. (canceled)
